(19) United States
(12) Patent Application Publication
(10) Pub. No.: US 2007/0007498 A1
(43) Pub. Date: Jan. 11, 2007

(54) Conduit body with friction reducing bushing

(75) Inventor: Roger Pyron, Bartlett, TN (US)

Correspondence Address: HOFFMAN & BARON, LLP, 6900 JERICHO TURNPIKE, SYOSSET, NY, 11791, US

(73) Assignee: Thomas & Betts International, Inc.

(21) Appl. No.: 11/477,065

(22) Filed: Jun. 28, 2006

Related U.S. Application Data
(60) Provisional application No. 60/696,711, filed on Jul. 5, 2005.

(51) Int. Cl. H02G 1/08

(52) U.S. Cl. 254/134.3 FT

(57) ABSTRACT

The present invention relates to an assembly including a conduit body for containing and accessing wires. The conduit body includes a housing having a generally continuous outer wall, wherein the wall defines a hollow interior chamber. Also, the wall has at least one opening extending therethrough, and at least one tubular hub projecting from the housing. Each tubular hub communicating with an opening. Additionally, a bushing is supported within each opening in the housing.

This application claims the benefit of U.S. Provisional Application No. 60/696,711 filed Jul. 5, 2005.

### BACKGROUND OF THE INVENTION

The present invention relates generally to a conduit body for containing and accessing electrical wires. More particularly, the invention relates generally to a bushing used in a conduit body that reduces friction for wires being pulled through the conduit body.

Electrical conduit systems are required in order to safely provide electric power to homes, commercial buildings, and the like. These conduit systems often include long runs of electrical conduit with frequent changes in direction, such as 90° turns, and interruptions with various couplings to accommodate bends or changes in direction. The conduits themselves serve to provide a protective housing for the wires therein and to route these wires throughout the building or other installation as required.

Conduit bodies are often installed at various locations throughout a conduit system in order to provide access to the wires in the conduits, or to route the wires through a bulkhead, an electrical equipment enclosure, a junction box, or other electrical fixture. Conventional conduit bodies can have openings through one or more side walls, as well as through the upper and lower walls.

Typically, insulated wires are inserted through an opening in one wall of the conduit body and out through an opening located in another wall of the conduit body. However, the friction caused by rubbing the wires against the inner edges of the conduit body makes it difficult to pull the wire through the conduit housing. While power pullers are used for this purpose, often the wires break while being pulled, leaving a partially pulled wire end that is very difficult to access within the conduit. In addition, when the wire is pulled across the inner edges of the conduit body, the abrasion on the insulation can damage the wire.

Attempts to minimize such friction associated with the wires rubbing against the inner portions of the conduit body have been less than satisfactory. It has long been known to use wire pulling compounds to lubricate the wire so that it can be more easily pulled through the hubs of the conduit body. However, as may be appreciated, these wire pulling compounds are cumbersome and messy to use. Alternatively, conduit bodies have been manufactured to include roller pins and/or smooth edges about the openings to minimize frictional engagement with the wires. However, such solutions unduly complicate the manufacturing of the conduit bodies and do not assist in minimizing friction in existing conduit bodies previously manufactured without such features.

Accordingly, it is desirable to provide an assembly having a conduit body with a friction reducing bushing positioned within the openings to the conduit body in order to minimize the friction engagement between the wires and the conduit body.

### SUMMARY OF THE INVENTION

The present invention relates to an assembly including a conduit body for containing and accessing wires. The conduit body includes a housing having a generally continuous outer wall, wherein the wall defines a hollow interior chamber. Also, the wall has at least one opening extending therethrough, and at least one tubular hub projecting from the housing and communicating with an opening. Additionally, a bushing is supported within each opening in the housing.

Additionally, other elements may be included as part of the assembly in accordance with the invention. In particular, the bushing can be rotatably supported in the opening. Also, the tubular hub can further include an annular rim projecting into the opening and an annular recess adjacent the annular rim. The bushing can include a first end disposed on a first surface of the annular rim and a second end disposed in the annular recess. The second end of the bushing can include an annular flange, the annular flange including an angled surface for snap-fit engagement of the bushing in the opening. Further, at least a portion of the second end of the bushing can be tapered. Further still, the bushing can be formed from a low friction material, such as PTFE, acetyl polymer and plastic. Yet further, the bushing can be secured within the opening by heat curling at least a portion thereof. Preferably, the housing includes two separate openings, each with a corresponding bushing therein and a tubular hub communicating therewith. Additionally, the housing can be formed in a generally elongate shape with the openings disposed at different ends thereof.

These and other objects, features, and advantages of this invention will become apparent from the following detailed description of illustrative embodiments thereof, which is to be read in connection with the accompanying drawings.

### BRIEF DESCRIPTION OF DRAWINGS

FIG. 1 is a perspective view, partially in section, of an assembly in accordance with an embodiment of the present invention.

FIG. 2 is a side cross-sectional view of the assembly of FIG. 1.

FIG. 3 is a side cross-sectional view of the assembly of FIG. 1 with a wire extending therethrough.

FIG. 4 is a front perspective view of a bushing from the assembly of FIG. 1.

FIG. 5 is a rear perspective view of a bushing from the assembly of FIG. 1.

FIG. 6 is a cross-sectional view of a bushing from the assembly of FIG. 1.

FIGS. 7 is a cross-sectional view of an alternative bushing in accordance with another embodiment of the present invention.

FIG. 8 is a cross-sectional view of a portion of the assembly showing the bushing of FIG. 7 installed therein.

### DETAILED DESCRIPTION OF THE PREFERRED EMBODIMENT

The present invention provides an assembly for use preferably in electrical conduit systems for containing and accessing wires. In particular, the assembly allows wires to be pulled through a conduit body without causing damage to the wires or their insulation.

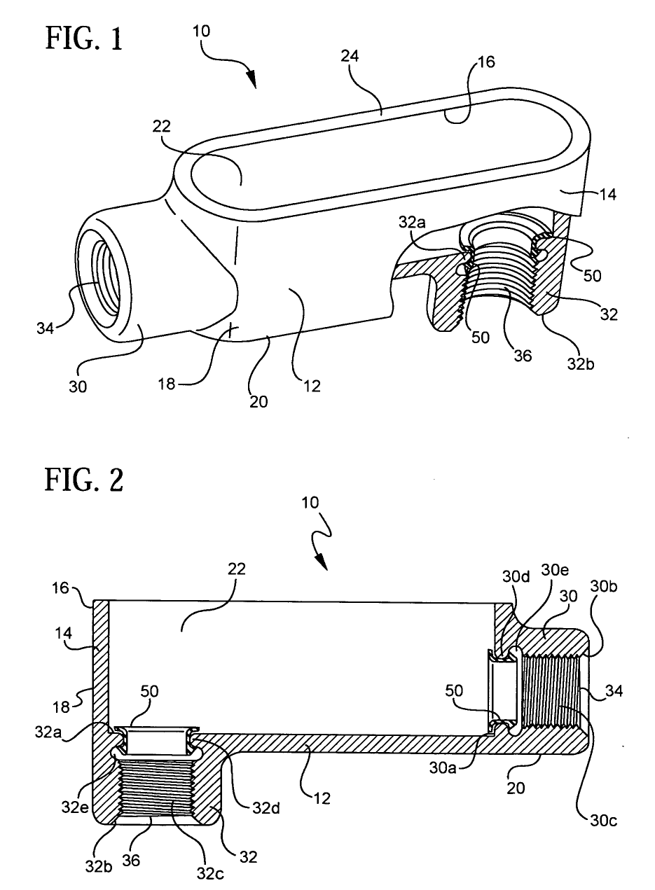

Referring to FIGS. 1-3, one of many different versions of conduit body assembly 10 is shown. Conduit body assembly 10 includes a conduit body 12 which is an elongate generally tubular shaped member formed preferably of metal. The conduit body 12 includes an upwardly extending sidewall 14 having an open upper end 16 and a closed lower end 18. The lower end 18 of sidewall 14 perimetrically bounds a lower wall 20 of the conduit body 12. The sidewall 14 and lower wall 20 together define a conduit body interior 22. The interior 22 may be enclosed by cover (not shown) over open upper end 16. Sidewall 14 defines at the open upper end 16 a generally oval-shaped smooth planar rim 24.

Conduit body 12 further includes a pair of elongate tubular projections or hubs 30 and 32 extending outwardly from conduit body interior 22. Each hub is an elongate member having an inner end 30a, 32a, and outer end 30b, 32b and a central bore 30c, 32c therebetween. The bore 30c, 32c is in communication with the interior 22 of body 12. Hubs 30 and 32 serve as points of ingress/egress for wire 40. Each hub 30, 32 defines an access port for such wire 40. Hubs 30, 32 may be internally threaded for accommodation of an externally threaded end of a conduit.

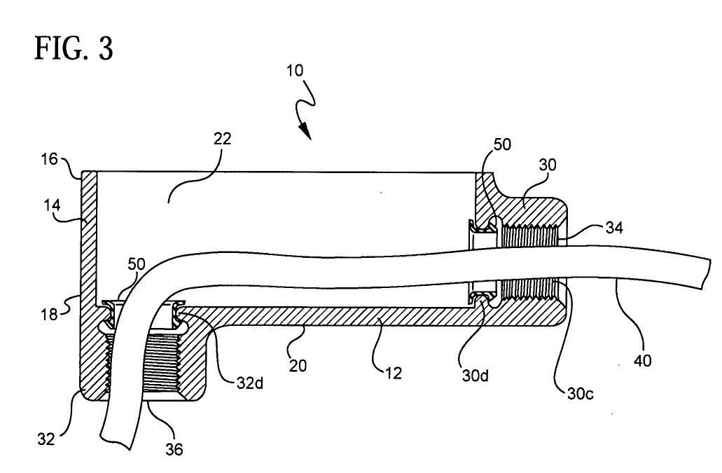

As particularly shown in FIG. 3, conduit body assembly 10 is designed to accommodate an insulated electrical wire 40 therethrough. As is well known in the art, the wire 40 is pulled through the conduit body by using the hubs 30 and 32 as ingress/egress ports. Such movement of the wire 40 through the conduit body 12 may have a tendency to abrade the insulation of the wire as it slides along the inner ends 30a, 32a of the conduit body 12 at hubs 30 and 32. Such abrading is particularly prevalent at the point of communication 30d, 32d between the hubs and the conduit body interior.

In order to reduce the friction between the conduit body and the wire 40 being pulled therethrough, a reduced friction surface in the form of a bushing 50 is provided at the inner ends 30a, 32a where the hubs 30 and 32 communicate with the conduit body interior 22.

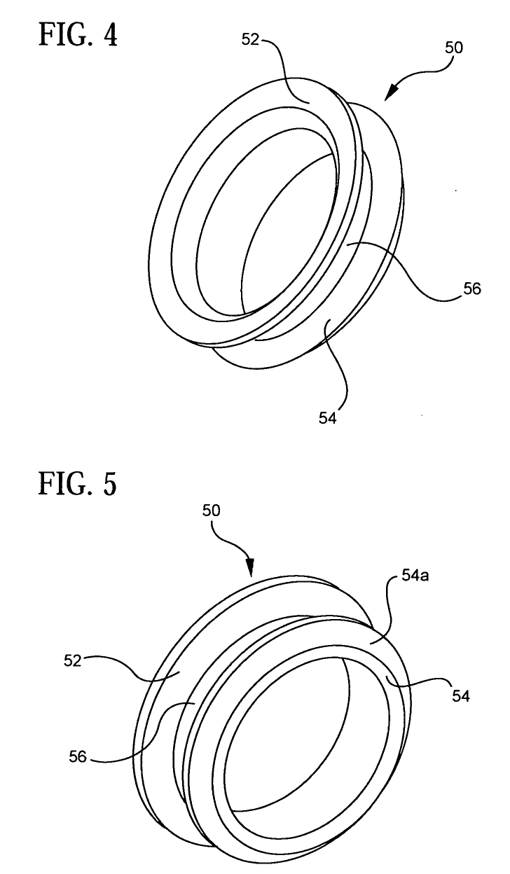

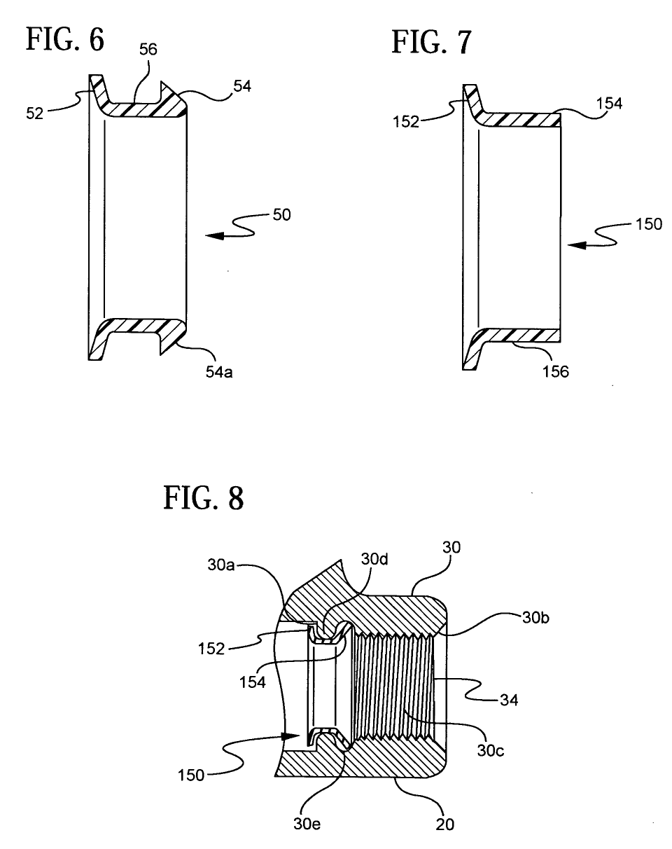

Referring particularly to FIGS. 4-6, a bushing 50 is shown in accordance with an embodiment of the present invention. Bushing 50 is an annular member having a first flared end 52, an opposed second end 54 and a cylindrical body 56 therebetween. The bushing 50 is preferably formed in a molding process and is formed of a low friction material such as polytetrafluoroethylene (PTFE) such as Teflon®, or acetyl polymer such as Delrin®. While these materials are disclosed, other low friction materials, as well as various plastics, may also be employed.

The bushing 50 is designed for accommodation within the connector body at the inner end 30a, 32a. In that regard, each hub of conduit body 12 includes an annular rim 30d, 32d which is inwardly projecting into the opening of the hub, and an annular recess 30e and 32e which is recessed into the hub. The bushing 50 is designed for snap-fit engagement with the annular rim 30d, 32d. When the bushing 50 is engaged, the first flared end 52 becomes disposed on a first surface of annular rim 30d, 32d, an the opposed second end 54 becomes disposed on a second surface of the annular rim 30d, 32d and is further accommodated in recess 30e, 32e. The opposed second end 54 of bushing 50 has an angled surface 54a to provide deflectable insertion of the bushing over the annular rim 30d, 32d, which allows for snap-in accommodation of the bushing within the hub in this embodiment. The present invention therefore provides a bushing which may be applied to an existing conduit body so as to provide a friction resisting surface in a location where the conductor is being pulled through the conduit body.

In an alternative embodiment of the present invention shown in FIGS. 7 and 8, a bushing 150 conforms to the shape of the conduit body opening by heat curling the bushing 150 to the conduit body. Although the bushing 150 is designed for accommodation within the conduit body at either inner end 30a, 32a, only the inner end 30a is shown in FIG. 8 for brevity and clarity.

The bushing 150 in accordance with a preferred embodiment, is also an annular member but is formed in a three-step process. First, a bushing blank 150 as shown in FIG. 7 is formed in a molding process of a plastic material. A variety of plastics may be used. The bushing blank 150 includes the first flared end 152 and an elongated cylindrical body 156. Second, the cylindrical body 156 of the bushing blank 150 is then inserted from inside the conduit body 12 into the hub 30, 32. Upon insertion the first flared end 152 should engage the surface of inner end 30a, 32a, while a portion of the elongate cylindrical body 156 engages a first surface of the annular rim 30d, 32d. Lastly, an end portion 154 of the cylindrical body 156 is heat curled into recess 30e, 32e, forming the tapered second end 154 of bushing 150 for securing engagement with annular rim 30d, 32d. This may be accomplished by introducing a heated mandrel from outside the conduit body 12 into hub 30, 32 to deform the plastic material and create a taper in the end portion 154 of the cylindrical body 156.

In all the preferred embodiments of the present invention, the bushing 50, 150 fully encircles and covers the annular rim 30d, 32d so that no portion thereof is exposed to a wire inserted therein.

Furthermore, both the snap-fit and the heat curled arrangements described in the present invention allow the bushing 50, 150 to be completely rotatable on the annular rim. The ability of the bushing to freely rotate within the hub provides additional friction reduction which allows the wire to be pulled easily in either direction.

Although illustrative embodiments of the present invention have been described herein with reference to the accompanying drawings, it is to be understood that the invention is not limited to those precise embodiments, and that various other changes and modifications may be applied therein by one skilled in the art without departing from the scope or spirit of the invention.

What is claimed is:

1. An assembly, comprising:
a conduit body for containing and accessing wires, said conduit body including
a housing having a generally continuous outer wall, said wall defining a hollow interior chamber, and having at least one opening extending therethrough, and
at least one tubular hub projecting from said housing and each of said at least one tubular hub communicating with one of said at least one opening; and
at least one bushing supported within each of said at least one opening.

2. The assembly of claim 1, wherein said bushing is rotatably supported in said opening.

3. The assembly of claim 1, wherein said tubular hub further includes an annular rim projecting into said opening.

4. The assembly of claim 3, wherein said tubular hub further includes an annular recess adjacent said annular rim.

5. The assembly of claim 4, wherein said bushing includes a first end disposed on a first surface of said annular rim and a second end disposed in said annular recess.

6. The assembly of claim 5, wherein said second end of said bushing includes an annular flange, said annular flange including an angled surface for snap-fit engagement of said bushing in said opening.

7. The assembly of claim 5, wherein at least a portion of said second end of said bushing is tapered.

8. The assembly of claim 1, wherein said bushing is formed from a low friction material.

9. The assembly of claim 8, wherein said low friction material is selected from the group consisting of PTFE, acetyl polymer and plastic.

10. The assembly of claim 1, wherein said bushing is secured within said opening by heat curling at least a portion of said bushing.

11. The assembly of claim 1, wherein said at least one opening includes two separate openings in said housing.

12. The assembly of claim 11, wherein said housing forms a generally elongate shape and said openings are disposed at different ends of said elongate shape.
